(19) United States
(12) Patent Application Publication
(10) Pub. No.: US 2017/0133666 A1
(43) Pub. Date: May 11, 2017

(54) NEGATIVE ELECTRODE FOR SECONDARY BATTERY AND MANUFACTURING METHOD THEREFOR

(71) Applicants: KOREA INSTITUTE OF SCIENCE AND TECHNOLOGY, Seoul (KR); SEOUL NATIONAL UNIVERSITY R&DB FOUNDATION, Seoul (KR)

(72) Inventors: Insuk CHOI, Seoul (KR); Myoungwoon MOON, Seoul (KR); Youngchang JOO, Seoul (KR); Minsuk JUNG, Seoul (KR)

(21) Appl. No.: 15/307,624

(22) PCT Filed: Oct. 8, 2014
(86) PCT No.: PCT/KR2014/009457

§ 371 Date: Jan. 10, 2017

(30) Foreign Application Priority Data
Apr. 30, 2014 (KR) 10-2014-0052579

(51) Int. Cl. H01M 4/1395; H01M 4/04; H01M 4/38

(52) U.S. Cl. CPC H01M 4/1395; H01M 4/386; H01M 4/0423; H01M 2004/027

(57) ABSTRACT

Provided are a negative electrode used for a secondary battery and capable of solving a problem caused by volume expansion of a lithium-negative electrode material alloy, and a manufacturing method thereof. A method of manufacturing a negative electrode for a secondary battery includes preparing a substrate, forming one or more nanorods by etching the substrate with an etching gas including oxygen, forming a metal electrode on the substrate and the nanorods, and forming a negative electrode active material layer on the metal electrode.

### TECHNICAL FIELD

The present invention relates to a negative electrode and, more particularly, to a negative electrode for a secondary battery, and a manufacturing method thereof.

### BACKGROUND ART

In the modern information society, power sources of portable electronic devices such as mobile phones, laptop computers, and personal digital assistants (PDAs) require smaller sizes and higher energy capacities. Furthermore, since oil prices are high nowadays, many people pay attention to energy and use of secondary batteries for, for example, hybrid electric vehicles (HEVs) is increased. Silicon is a negative electrode material for a lithium secondary battery and may replace carbon.

Commonly-used graphite has a theoretical capacity of 372 mAh/g, whereas silicon has a theoretical capacity of about 4200 mAh/g. However, when a battery is actually produced using a silicon negative electrode, the battery merely has a charge capacity of about 3260 mAh/g, a discharge capacity of about 1170 mAh/g, and a coulombic efficiency of 35% (Electrochem. Solid State Lett., P.A306, Vol 7, 2004).

In addition, when the battery is repeatedly charged and discharged over five cycles, the capacity thereof is rapidly reduced to about 300 mAh/g which is merely about 10% of the original capacity thereof. This is because a lithium-silicon alloy (Li—Si alloy, Li₂₂Si₅) is formed when lithium is inserted, and volume expansion occurs by about four times. Stress in silicon due to the volume expansion causes cracking and structural collapsing. The cracking and collapsing lead to breakage of an electron pathway of an electrode, form a dead volume in the electrode, and cause reduction in capacity of a silicon negative electrode. Accordingly, as the battery is repeatedly charged and discharged, the above phenomenon is accelerated and thus rapid reduction in capacity occurs. This life deterioration phenomenon significantly occurs in a bulk silicon film or particles of micrometers in size.

### DETAILED DESCRIPTION OF THE INVENTION

### Technical Problem

The present invention provides a negative electrode used for a secondary battery and capable of solving a problem caused by volume expansion of a lithium-negative electrode material alloy, and a manufacturing method thereof. However, the scope of the present invention is not limited thereto.

### Technical Solution

According to an aspect of the present invention, there is provided a method of manufacturing a negative electrode for a secondary battery, the method including preparing a substrate, forming one or more nanorods by etching the substrate with an etching gas including oxygen, forming a metal electrode on the substrate and the nanorods, and forming a negative electrode active material layer on the metal electrode.

The forming one or more nanorods by etching the substrate with the etching gas including oxygen may include forming the one or more nanorods on the substrate by performing an oxygen-containing plasma etching process.

The substrate may include a high molecular weight polymer.

The high-molecular polymer may include polyimide.

The metal electrode may include copper.

The negative electrode active material layer may include silicon.

The metal electrode may include one or more nanoholes on the substrate.

The nanorods may be integrally formed with the substrate and penetrate through the nanoholes.

The nanorods may be spaced apart from side walls of the nanoholes.

The nanorods may extend upward from a top surface of the substrate.

The forming a metal electrode on the substrate and the nanorods may include depositing a metal on the substrate by performing a thermal evaporation process.

The thermal evaporation process may be performed under a condition such that an overhang the metal is formed on upper parts of the nanorods.

According to another aspect of the present invention, there is provided a negative electrode for a secondary battery, the negative electrode including a substrate, one or more nanorods formed on the substrate, a metal electrode formed on the substrate and the nanorods, and a negative electrode active material layer formed on the metal electrode.

### Advantageous Effects

As described above, according to an embodiment of the present invention, a negative electrode used for a secondary battery and capable of solving a problem caused by volume expansion of a lithium-negative electrode material alloy, and a manufacturing method thereof may be implemented. However, the scope of the present invention is not limited to the above effect.

### DESCRIPTION OF THE DRAWINGS

FIG. 1 is a flowchart of a method of manufacturing a negative electrode for a secondary battery, according to embodiments of the present invention.

FIG. 2 is a perspective diagram for describing the negative electrode manufacturing method according to embodiments of the present invention.

FIG. 3 is a cross-sectional diagram of a negative electrode manufactured using the negative electrode manufacturing method according to embodiments of the present invention.

FIG. 4 shows electron microscope images of a negative electrode manufactured using a comparative example of the negative electrode manufacturing method according to embodiments of the present invention.

FIG. 5 shows electron microscope images of a negative electrode manufactured using the negative electrode manufacturing method according to embodiments of the present invention.

FIG. 6 is a graph showing current-rate (C-rate) test results of negative electrodes manufactured using the negative electrode manufacturing method according to embodiments of the present invention, and comparative examples.

### BEST MODE

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the sizes of elements may be exaggerated for convenience of explanation.

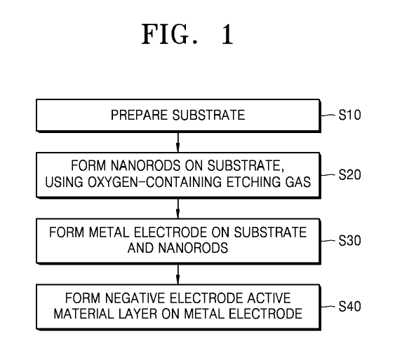

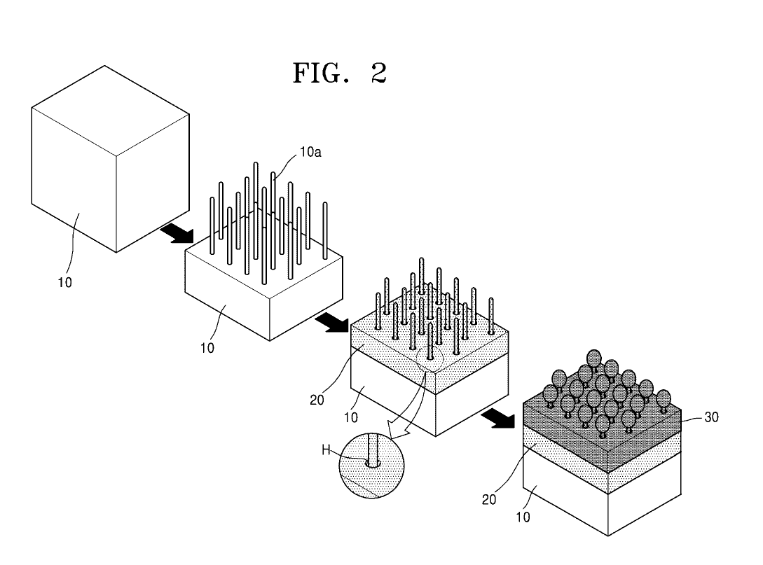

FIG. 1 is a flowchart of a method of manufacturing a negative electrode for a secondary battery, according to embodiments of the present invention, and FIG. 2 is a perspective diagram for describing the negative electrode manufacturing method according to embodiments of the present invention.

Referring to FIGS. 1 and 2, the negative electrode manufacturing method according to embodiments of the present invention may include preparing a substrate 10 (S10), forming one or more nanorods 10a on the substrate 10, using an etching gas including oxygen (S20), forming a metal electrode 20 on the substrate 10 and the nanorods 10a (S30), and forming a negative electrode active material layer 30 on the metal electrode 20 (S40).

For example, the substrate 10 serving as a base layer is prepared, and the nanorods 10a are formed on the substrate 10 by etching the substrate 10 with the etching gas including oxygen. Thereafter, the metal electrode 20 may be formed on the substrate 10 and the nanorods 10a formed on the substrate 10, using deposition, and then the negative electrode active material layer 30 may be formed by depositing a negative electrode material on the metal electrode 20.

The substrate 10 may be made of, for example, a high-molecular polymer including polyimide or the like, and the nanorods 10a may be formed by etching an upper part of the substrate 10 having a flat top surface (e.g., parts extending downward from the top surface of the substrate 10).

The nanorods 10a obtained by etching the upper part of the substrate 10 may be formed integrally with the substrate 10 in a direction extending upward from the exposed top surface of the substrate 10. Herein, the direction extending upward from the exposed top surface of the substrate 10 may include a direction perpendicular to the substrate 10. Alternatively, the direction extending upward from the exposed top surface of the substrate 10 may include a tilted direction proceeding away from the exposed top surface of the substrate 10 without being perpendicular to the top surface of the substrate 10. The nanorods 10a may be evenly formed over the whole exposed surface of the substrate 10. The nanorods 10a may include a plurality of nanorods 10a, and an average thickness and an average height of the nanorods 10a and an average distance between neighboring nanorods 10a may be several ten nanometers to several hundred nanometers.

A method of obtaining the nanorods 10a by etching the upper part of the substrate 10 may include a dry etching process using surface abrasion due to momentum transfer occurring when ions accelerated by an electric field collide with a target material to be etched. The dry etching process may include, for example, plasma etching. The plasma etching physically removes a target material by allowing plasma, which is an ionized gas having the same number of positive and negative charges, to collide with the surface of the target material, or etches a material in an to anisotropic manner by cutting chemical bonds in the material to be rapidly etched with radicals.

Using the plasma etching, nanosized rods may be formed by performing, for example, O₂ plasma etching on, for example, the polyimide substrate 10 in a vacuum chamber. When O₂ plasma etching is performed on the polyimide substrate 10 as described above, the nanorods 10a may be formed integrally with the substrate 10 in tiny and dense shapes.

The metal electrode 20 including one or more nanoholes H may be formed on the substrate 10 having the nanorods 10a thereon. The metal electrode 20 may include, for example, a copper electrode. The nanorods 10a formed on the substrate 10 may be configured to penetrate through the nanoholes H. For example, when the nanoholes H include a plurality of nanoholes H and the nanorods 10a include a plurality of nanorods 10a, each of the nanorods 10a may be configured to penetrate through each of the nanoholes H. As another example, the nanoholes H may be configured to have the nanorods 10a penetrating therethrough.

The nanorods 10a may be spaced apart from side walls of the nanoholes H.

For example, the nanorods 10a may not contact but spaced apart from all side walls of the nanoholes H. As another example, the nanorods 10a may not contact but spaced apart from some side walls of the nanoholes H. The metal electrode 20 including the nanoholes H may be obtained by depositing a metal on the substrate 10 having the nanorods 10a thereon, using vapor deposition.

The vapor deposition includes physical vapor deposition (PVD) or chemical vapor deposition (CVD). The PVD includes sputtering, thermal evaporation, or the like, and the CVD includes plasma-assisted chemical vapor deposition (PACVD), plasma-enhanced chemical vapor deposition (PECVD), atmospheric pressure chemical vapor deposition (APCVD), or the like.

When the height of the nanorods 10a is large and the distance between neighboring nanorods 10a is small, the nanorods 10a may obstruct the flow of a source of a metal to be deposited. When the source of the metal to be deposited is diagonally provided onto the top surface of the substrate 10, the obstruction is more serious. Due to the obstruction of the nanorods 10a, the metal may not be deposited and the nanoholes H may be formed around the nanorods 10a. Furthermore, in a thermal evaporation process of a metal, the metal may overhang upper parts of the nanorods 10a. The overhangs may obstruct the flow of a source of a metal to be deposited around the nanorods 10a, and thus the metal may not be deposited and the nanoholes H may be formed around the nanorods 10a. The nanoholes H may be formed around the nanorods 10a due to the obstruction of the nanorods 10a or the overhangs, and the nanorods 10a may be spaced from the side walls of the nanoholes H by a predetermined distance.

The metal electrode 20 may include a metal consisting of a plurality of grains (e.g., copper), and the nanoholes H may be formed among the grains. The above configuration may be implemented in such a manner that an average grain size of the deposited metal electrode 20 corresponds to an average distance between neighboring nanoholes H. A flexible device element having the above grain size may facilitate dissipation of a potential and thus prevent electrical or mechanical destruction of a thin metal film due to repeated bending. According to modified embodiments of the present invention, the metal electrode 20 may include a metal consisting of a plurality of grains (e.g., copper), and at least one of the grains may include one or more nanoholes H.

The negative electrode active material layer 30 may include, for example, silicon, carbon, aluminum, tin, or bismuth, and may be deposited on the nanorods 10a formed on the substrate 10, using, for example, vapor deposition. However, since, for example, silicon included in the negative electrode active material layer 30 generates a silicon-lithium alloy during charge and discharge, for example, during electrochemical reaction with lithium, volume expansion of the silicon-lithium alloy causes cracking and structural collapsing and thus very rapid reduction in capacity occurs.

The cracking and collapsing lead to breakage of an electron pathway of an electrode, generate a dead volume in the electrode, and cause reduction in capacity of a silicon negative electrode. Accordingly, as a battery is repeatedly charged and discharged, the above phenomenon is accelerated and thus rapid reduction in capacity occurs. This phenomenon is called life deterioration.

However, the above problem may be solved by the negative electrode manufacturing method according to embodiments of the present invention. For example, using the tiny nanorods 10a formed on and integrally with the substrate 10, the problem of cracking and structural collapsing due to volume expansion of a silicon-lithium alloy may be solved. For example, when the metal electrode 20 is deposited on the tiny nanorods 10a formed integrally with the substrate 10 and a silicon layer is deposited on the metal electrode 20, silicon nanorods may be formed, electrons may move appropriately, and stress in silicon during charge and discharge may be mitigated. In addition, since silicon is deposited on the tiny nanorods 10a, a surface area of silicon may be increased and thus capacity is increased.

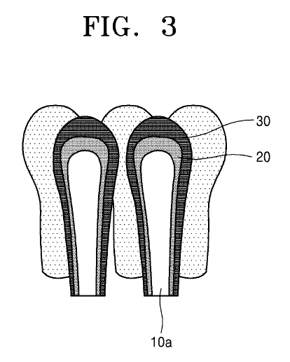

FIG. 3 is a cross-sectional diagram of a negative electrode manufactured using the negative electrode manufacturing method according to embodiments of the present invention.

Referring to FIG. 3, in the negative electrode manufactured using the negative electrode manufacturing method according to embodiments of the present invention, for example, the metal electrode 20 may be deposited on the nanorods 10a, and the negative electrode active material layer 30 may be formed on the metal electrode 20. For example, a copper electrode may be deposited by performing a thermal evaporation process on, for example, the nanorods 10a formed by performing, for example, an O₂ plasma process on the substrate 10 made of polyimide, and then a silicon layer may be deposited by performing, for example, a thermal evaporation process on the copper electrode.

For a better understanding of the present invention, a description is now given of a test example to which the above-described technical features are applied. However, the following test example is merely given for a better understanding of the present invention, and the present invention is not limited to the following test example.

### TEST EXAMPLE

In the test example, a substrate made of polyimide is prepared in a vacuum chamber, tiny nano-sized rods are formed by performing O₂ plasma etching on the polyimide substrate for an hour at a flow rate of −30 mtorr and an acceleration voltage of −400 V, the substrate having the nanorods thereon is moved into another vacuum chamber, and then a copper electrode is deposited by performing a thermal evaporation process using copper on the substrate having the nanorods thereon. Thereafter, a silicon layer is formed by performing a thermal evaporation process using silicon on the deposited copper electrode.

### Comparative Example 1

In the comparative example 1, a negative electrode for a secondary battery is manufactured by omitting O₂ plasma etching not to form nanorods, and by forming a copper electrode and a silicon layer under the same condition as the test example.

### Comparative Example 2

In the comparative example 2, a negative electrode for a secondary battery is manufactured by performing CF4 plasma etching instead of O₂ plasma etching under the same condition as the test example.

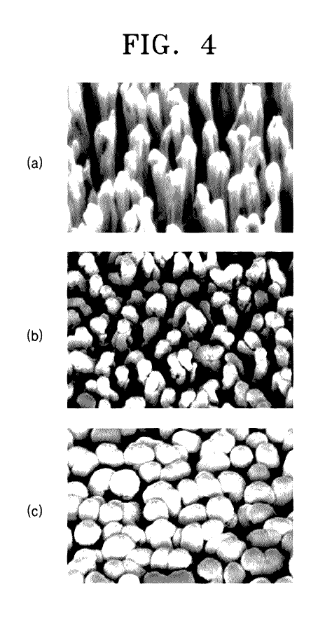

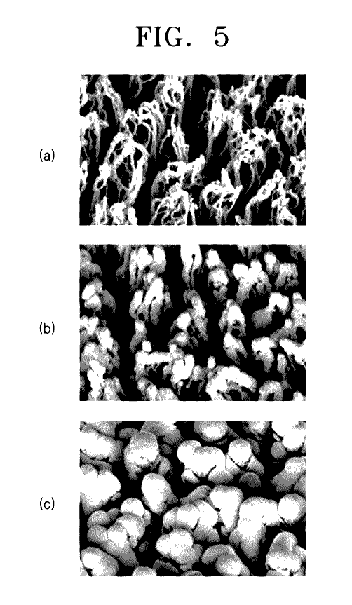

In FIGS. 4 and 5, (a), (b), and (c) show images of nanorods formed on substrates, copper electrodes deposited on the nanorods, and silicon layers formed on the copper electrodes based on the etching processes of the comparative example 2 and the test example of the present invention, respectively. Referring to

FIGS. 4 and 5, compared to the comparative example 2 (FIG. 4), in the negative electrode manufactured using the negative electrode manufacturing method according to the test example of the present invention (FIG. 5), the nanorods of the test example are tinier and denser than those of the comparative example 2 and, as a result, the surface area of the silicon layer according to the test example of the present invention is larger than that of the silicon layer according to the comparative example 2.

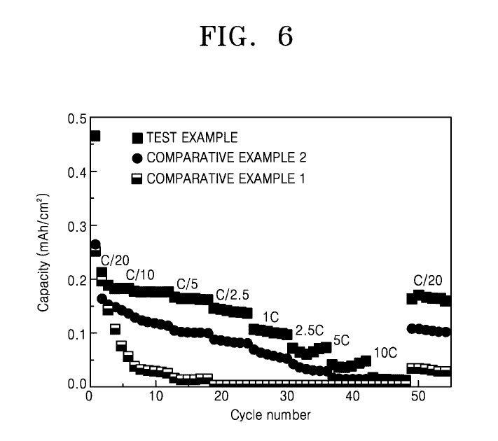

FIG. 6 is a graph showing current-rate (C-rate) test results of negative electrodes manufactured using the negative electrode manufacturing method according to embodiments of the present invention, and the comparative examples.

Referring to FIG. 6, under the same C-rate condition, the test example of the present invention shows superior C-rate test results compared to the comparative examples 1 and 2. That is, when the nanorods integrally formed on the substrate are tinier and denser as in the test example of the present invention, capacity based on the number of charge and discharge cycles of the negative electrode has a higher value. This is because tiny nanorods increase the surface area of a silicon layer deposited on the nanorods and thus capacity is increased.

As described above, based on the negative electrode manufacturing method according to embodiments of the present invention, one or more tiny nanorods integrated with a substrate may be formed using an etching gas including oxygen, and a negative electrode used for a secondary battery and including the tiny and dense nanorods may be manufactured by depositing a metal electrode on the formed nanorods and depositing a negative electrode active material layer on the deposited metal electrode. The above-described negative electrode according to embodiments of the present invention may solve a problem of cracking and structural collapsing due to volume expansion of, for example, a lithium-silicon alloy, and may increase capacity based on the number of charge and discharge cycles due to increase in the surface area of a silicon layer deposited on nanorods.

While the present invention has been particularly shown and described with reference to embodiments thereof, it will be understood by one of ordinary skill in the art that various changes in form and details may be made therein without departing from the spirit and scope of the present invention as defined by the following claims.

1. A method of manufacturing a negative electrode for a secondary battery, the method comprising:
preparing a substrate;
forming one or more nanorods by etching the substrate with an etching gas comprising oxygen;
forming a metal electrode on the substrate and the nanorods; and
forming a negative electrode active material layer on the metal electrode.

2. The method of claim 1, wherein the forming one or more nanorods by etching the substrate with the etching gas comprising oxygen comprises forming the one or more nanorods on the substrate by performing an oxygen-containing plasma etching process.

3. The method of claim 1, wherein the substrate comprises a high molecular weight polymer.

4. The method of claim 3, wherein the high molecular weight polymer comprises polyimide.

5. The method of claim 1, wherein the metal electrode comprises copper.

6. The method of claim 1, wherein the negative electrode active material layer comprises silicon.

7. The method of claim 1, wherein the metal electrode comprises one or more nanoholes on the substrate.

8. The method of claim 7, wherein the nanorods are integrally formed with the substrate and penetrate the nanoholes.

9. The method of claim 7, wherein the nanorods are spaced apart from side walls of the nanoholes.

10. The method of claim 7, wherein the nanorods extend upward from a top surface of the substrate.

11. The method of claim 1, wherein the forming a metal electrode on the substrate and the nanorods comprises depositing a metal on the substrate by performing a thermal evaporation process.

12. The method of claim 11, wherein the thermal evaporation process is performed under a condition such that an overhang of the metal is formed on upper parts of the nanorods.

13. A negative electrode for a secondary battery, the negative electrode comprising:
a substrate;
one or more nanorods formed on the substrate;
a metal electrode formed on the substrate and the nanorods; and
a negative electrode active material layer formed on the metal electrode.
